(19) United States
(12) Patent Application Publication
(10) Pub. No.: US 2015/0163282 A1
(43) Pub. Date: Jun. 11, 2015

(54) SYSTEM AND METHOD FOR ACCESSING REMOTE DISK IMAGES USING A VMEDIA CLIENT AND THROUGH A REMOTE ACCESS APPLIANCE

(71) Applicant: AVOCENT HUNTSVILLE CORP., Huntsville, AL (US)

(72) Inventors: Craig S. Siegman, Pembroke Pines, FL (US); Joseph Amirthasamy, Plantation, FL (US); George N. Griffin, Coral Springs, FL (US)

(21) Appl. No.: 14/412,842

(22) PCT Filed: Jul. 9, 2013
(86) PCT No.: PCT/US13/49737

§ 371 Date: Jan. 5, 2015

Related U.S. Application Data
(60) Provisional application No. 61/669,844, filed on Jul. 10, 2012.

(51) Int. Cl. H04L 29/08; G06F 17/30

(52) U.S. Cl. CPC H04L 67/025; G06F 17/30067

(57) ABSTRACT

A method is disclosed for remotely accessing disc images using a KVM/vMedia client. device communicates a first message to a controller at a remote site. The first message is an inquiry of available disk images from at least one disk image server. The controller responds to the first message with a second message that identifies at least one available disk image file on the disk image server. The KVM/vMedia client then transmits a third message representing a selected disk image file back to the controller. The controller responds by mounting the selected disk image file in the controller using a predetermined file system, and then exposing the mounted disk image file to a host computing system in communication with the controller for use by the KVM/vMedia client.

### CROSS-REFERENCE TO RELATED APPLICATIONS

This application claims priority to U.S. Provisional Application No. 61/669,844, filed on Jul. 10, 2012. The entire disclosure of the above application is incorporated herein by reference.

### FIELD

The present disclosure relates to virtual media systems, and more particularly to a system and method that enables a vMedia client running on a user's device to access remote disk images through a remote access appliance such as a KVM appliance or a BMC, and which enables the user to use the remote disk images just as if the information was being obtained from a local virtual media device connected to the user's device.

### BACKGROUND

The statements in this section merely provide background information related to the present disclosure and may not constitute prior art.

In some computing environments a user at an electronic device, such as a workstation computer or laptop, may wish to access remote disk images via a network connection. However, disk images tend to be large files that are often needed by multiple users and multiple servers. As such, the disk images may not be accessible directly from the client. For example, if a user is accessing a host server remotely via a remote access device such as a KVM (keyboard, video and mouse) appliance or BMC (baseband management controller), remote from a facility where the host server is located, then frequently a firewall in the facility will be present. The firewall may not let the user's workstation view or access other servers in the facility except for the one server for which the user has remote access privileges. Accordingly, in this example the user would only have access to disk images stored on the one server that he has access privileges to, even though other servers have disk images that the user may wish to use.

Other implementations have allowed the user to enter information into a Web GUI (graphical user interface) on the exact network path to a disk image but have not allowed for querying to determine which images may be available. Such implementations also do not allow for reporting real time status. And such implementations would not be useful when the user may not be using a Web GUI at all, but may be accessing the server through a KVM/vMedia (virtual media) client that was started directly and not from a Web GUI. In that case it is vital that the ability to select, control and manage virtual disk selection, mounting and unmounting be done through the KVM/vMedia client.

### SUMMARY

In one aspect the present disclosure relates to a method for remotely accessing disc images using a KVM/vMedia client. The method may comprise using the KVM/vMedia client on a user's computing device to communicate a first message to a controller at a site. The first message may operate as an inquiry of available disk images from at least one disk image server. The first message may be received at the controller and the controller may transmit back to the computing device a second message that identifies at least one available disk image file on the disk image server. The KVM/vMedia client may then be used to transmit a third message representing a selected disk image file back to the controller. The controller may receive the third message and mounts the selected disk image file in the controller using a predetermined file system, and then exposes the mounted disk image file to a host computing system in communication with the controller. The KVM/vMedia client may then access the host computing system via the controller and display the mounted disk image file on the user's computing device.

In another aspect the present disclosure relates to a method for remotely accessing disc images using a KVM/vMedia client. The method may comprise using the KVM/vMedia client on a user's computing device to communicate a first universal resource locator (URL) to a controller at a site. The first URL may operate as an instruction to cause the controller to access a selected disk image server and to obtain information on disk image files available from the selected disk image server. The controller may be used to receive the first URL and to transmit back to the user's computing device a directory of available disk image files on the selected disk image server. The KVM/vMedia client may display the directory on a display of the user's computing device and may generate a second URL in accordance with a selection of a specific disk image file by the user. The KVM/vMedia client then transmits the second URL back to the controller. The controller may be used to receive the second URL and to mount a specific disk image file associated with the second URL, using a predetermined file system, and to expose the mounted disk image file to a host computing system in communication with the controller. The KVM/vMedia client may then access the host computing system via the controller and display the mounted disk image file on the user's computing device.

In still another aspect the present disclosure relates to a system for remotely accessing disc images using a KVM/vMedia client. The system may comprise a KVM/vMedia client running on a user's computing device and configured to communicate a first message to a controller at a site. The first message may operate as an inquiry of available disk images from at least one disk image server. The controller may be configured to receive the first message and to transmit back to the computing device a second message that identifies at least one available disk image file on the disk image server. The controller may also be configured to receive a third message from the KVM/vMedia client representing a selected disk image file, and to mount the selected disk image file in the controller using a predetermined file system. The controller may also be configured to expose the mounted disk image file to a host computing system in communication with the controller for access and use by the user's computing device.

### BRIEF DESCRIPTION OF THE DRAWINGS

The drawings described herein are for illustration purposes only and are not intended to limit the scope of the present disclosure in any way.

FIG. 1 is a high level block diagram illustration of a system in accordance with one embodiment of the present disclosure that enables a KVM/vMedia client running on a user's device to remotely access disk image files via a KVM device (KVM appliance or BMC);

FIG. 2 is a high level flowchart illustrating a plurality of operations that the system of FIG. 1 may perform when the user accesses remote disk images via the KVM/vMedia client; and

FIGS. 3A and 3B show another flowchart which sets forth a detailed sequence of operations that may occur when a user specifies a specific disk image server via a URL.

### DETAILED DESCRIPTION

The following description is merely exemplary in nature and is not intended to limit the present disclosure, application, or uses. It should be understood that throughout the drawings, corresponding reference numerals indicate like or corresponding parts and features.

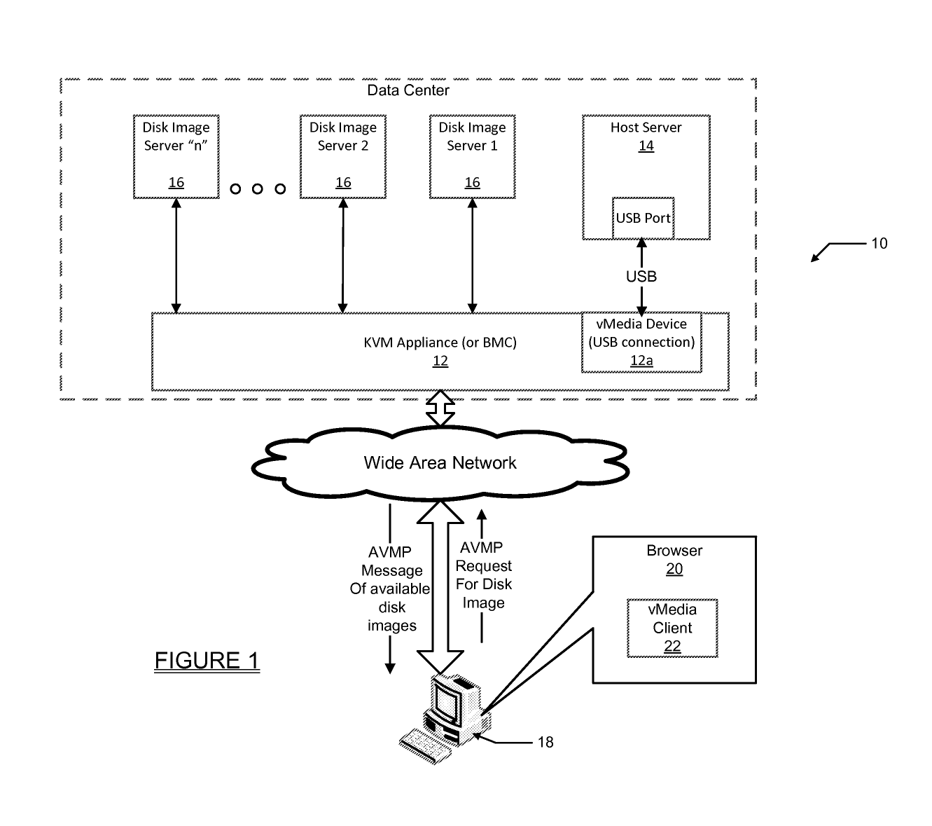

Referring to FIG. 1 there is shown a system 10 in accordance with one embodiment of the present disclosure for enabling a KVM/vMedia client to access remote disk images via a remote KVM device 12. The remote KVM device 12 may be a KVM appliance or a baseband management controller (“BMC”), but simply for convenience the following discussion will reference the KVM device as “KVM appliance 12.”

The KVM appliance 12 uses a vMedia device 12a which communicates via a USB connection to the USB port of a host server 14. One or more separate disk image servers 16 may also be in communication with the KVM appliance 12. The KVM appliance 12, the host server 14 and the disk image servers 16 in this example are all located in a data center, but they need not be clustered in one data center. A user may use, as one example, a PC workstation 18, running a browser 20 to connect to the KVM appliance 12. The browser 20 may have a KVM/vMedia client 22 running in it. It will also be appreciated that while the user's electronic device has been shown as a PC workstation 18, virtually any electronic device capable of running a KVM/vMedia client could be used. Accordingly and without limitation, laptops, smartphones and computing tablets are just some of the different types of electronic devices that could be used in place of PC workstation 18. And it will also be appreciated that a web browser may not be needed, provided that an application loaded on (or downloaded to) the device acts as the KVM/vMedia client.

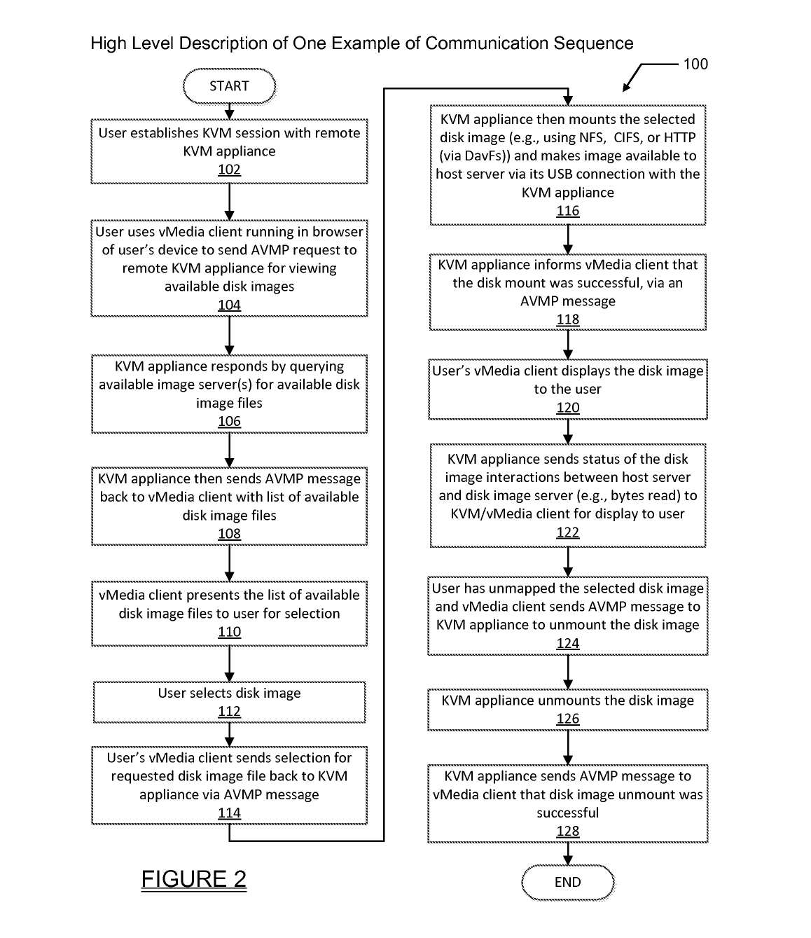

Referring now to FIG. 2, a flowchart 100 is shown of various operations that may be performed in providing requested disk image files to the KVM/vMedia client 22. This example assumes that the KVM/vMedia client is running in the browser 20, although as noted above, that will not be the case if an application has been loaded on (or downloaded to) the user's workstation 18 (or other electronic device that the user is using). At operation 102 the user establishes a KVM session with the KVM appliance 12. At operation 104 the user uses the KVM/vMedia client 22 to send a message request to the KVM appliance 12 to view available disk images on one or more of the disk image servers 16. In one example the message may be an AVMP message, and the following discussion will assume that AVMP messages are being communicated between the KVM/vMedia client 22 and the KVM appliance 12.

At operation 106 the KVM appliance 12 responds by querying the specified disk image server(s) 16 for available disk image files. At operation 108 the KVM appliance 12 then sends an AVMP message back to the KVM/vMedia client 22 with a list of available disk image files. At operation 110 the KVM/vMedia client 22 presents the list of available disk image files to the user for selection. At operation 112 the user makes a selection for a specific disk image, as indicated. At operation 114 the user's KVM/vMedia client 22 sends the user's selection for one or more specific requested disk image files back to the KVM appliance 12 via an AVMP message. When the KVM appliance 12 receives the AVMP message it mounts the requested disk images in the KVM appliance 12 and exposes the mounted images to the host server 14 via the USB connection with the vMedia device 12a within the KVM appliance, as indicated at operation 116. The mounting may be accomplished by using an NFS (Network File System), CIFS (Common Internet File System) or HTTP (via DavFS) mount.

At operation 118 the KVM appliance 12 may then inform the KVM/vMedia client 22 that the disk mount was successful via an AVMP message. At operation 120 the user's KVM/vMedia client 22 displays the mounted disk image (or images) to the user via the display on the PC workstation 18. At operation 122 the KVM appliance 12 may send an AVMP status message of the disk image interactions between the host server 14 and the disk image server 16, for example the bytes read, which the KVM/vMedia client 22 may display to the user.

At operation 124, assume that the user has unmapped the selected disk image (or images). The KVM/vMedia client 22 sends an AVMP message to the KVM appliance 12 that tells the KVM appliance to unmount the disk image (or images). The KVM appliance 12 will then unmount the disk image (or images), as indicated at operation 126. It will be appreciated that the “mounting” and “unmounting” of disk images in this example is performed pursuant to requirements of the LINUX® operating system, which the KVM appliance 12 in this example is running. The KVM appliance 12 may then send an AVMP message back to the KVM/vMedia client 22 informing the client that the disk image unmounting was successful, as indicated at operation 128.

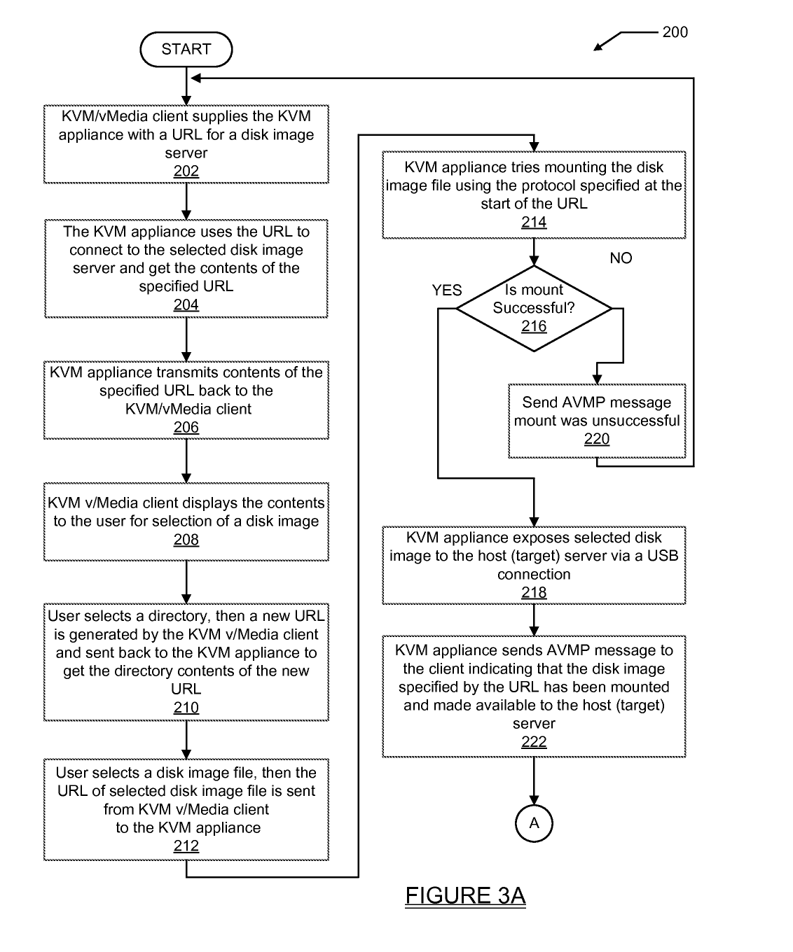

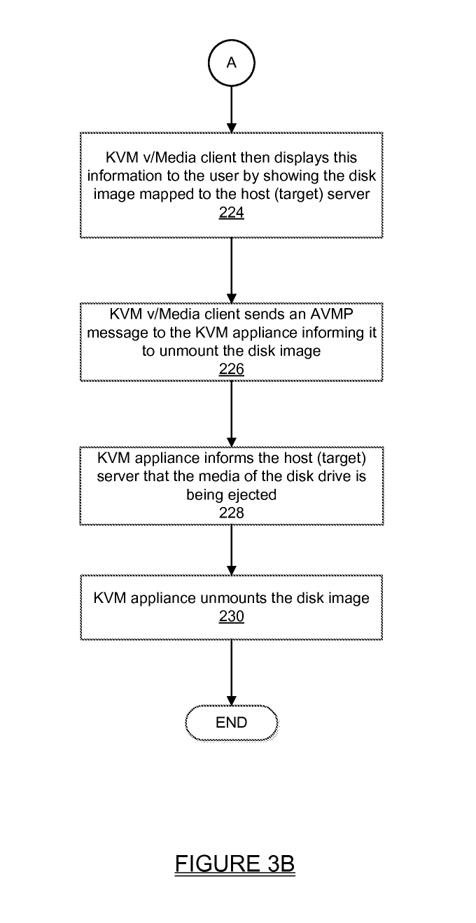

Referring now to FIGS. 3A and 3B, a flowchart 200 is presented which provides an example of operation of the system 10 where the user specifies the exact disk image server 16 via the URL he/she supplies. Again, it will be appreciated that a BMC could be substituted for the KVM appliance 12, and that the reference to AVMP messages is merely intended to show one type of message protocol that may be used to provide the status updates to the KVM/vMedia client 22.

At operation 202 the KVM/vMedia client 22 supplies the KVM appliance 12 with a URL for a disk image server 16 (i.e., one of the disk image servers 1, 2, . . . n). At operation 204 the KVM appliance 12 then uses the URL to connect to the disk image server 16 and get the contents of the specified URL. For example, a URL may appear as: nfs://diskimageserver1/diskimages. The portion of the URL that designates “diskimageserver1” would be the name of the disk image server that has to be resolved to an IP address. The portion “diskimages” would be the name of a directory on the disk image server. Once the KVM appliance 12 has the contents of the specified URL it transmits the contents back to the KVM v/Media client 22, as indicated at operation 206. The KVM v/Media client 22 displays the contents to the user for selection of a disk image, as indicated at operation 208. The names of sub-directories may have an indication that they are directories. Now assume that the user selects a directory, which results in a new URL being generated by the KVM v/Media client 22 (e.g. nfs://diskimageserver1/diskimages/subdir1), which is sent back to the KVM appliance 12 as an instruction to get the directory contents of the new URL, as indicated at operation 210. Now assume that the user selects a disk image file, in which case the URL of that selected disk image file is sent from the KVM v/Media client 22 to the KVM appliance 12 (e.g. nfs://diskimageserver1/diskimages/diskimage1.iso), as indicated at operation 212. The KVM appliance 12 will then try to mount the disk image file using the protocol specified at the start of the URL, as indicated at operation 214. For this example as explained thus far, the protocol may be NFS. Other protocols available would be, without limitation, SMB (Samba or technically CIFS) and http (DavFS).

If the mount at operation 214 is successful, as checked at operation 216, then the KVM appliance 12 exposes that disk image to the host (target) server 14 via its USB connection with the host server, as indicated at operation 218. For all intents and purposes the host (target) server 14 thinks that there is a physical disk drive with the disk named by the image file available for its use. At the same time the KVM appliance 12 exposes the disk image to the host (target) server 14, it sends an AVMP message to the client indicating that the disk image specified by the URL has been mounted and has been made available to the host (target) server 14, as indicated at operation 222. If the attempted mounting of the disk image file was not successful, then the KVM appliance 12 may send an AVMP message to the KVM v/Media client 22 informing the client of this event, as indicated at operation 220, and operation 202 may be re-performed. Assuming that the mounting of the disk image was successful, the KVM v/Media client 22 then displays this information to the user by showing the disk image mapped to the host (target) server 14, as indicated at operation 224 (FIG. 3B). As transactions take place that move data from the disk image file to the host (target) server 14, the KVM appliance 12 monitors those transactions and sends AVMP messages to the KVM v/Media client 22 informing it of how much data has been read by the host (target) server from the disk image.

If the user wants to unmap the disk image, the user does so through the KVM v/Media client 22. In FIG. 3B, at operation 226, the KVM v/Media client 22 sends an AVMP message to the KVM appliance 12 instructing it to unmount the disk image. The KVM appliance 12 informs the host (target) server 14 that the media of the disk drive is being ejected, as indicated at operation 228, so the host (target) server can clean up its interactions with the disk image. The KVM appliance 12 then unmounts the disk image, as indicated at operation 230, after which the disk image is no longer available to the host (target) server 14.

The system 10 thus allows users to access disk image files when using a KVM/vMedia client, which may not be directly accessible to the user, and further which may be stored on multiple different disk image servers. Since the KVM/vMedia client 22 is something that the user will typically be comfortable with using, this provides a highly convenient and easy to use system that enables the user to select, control and manage virtual disk selection mounting and unmounting through the KVM/vMedia client 22. The system 10 also has the advantage of reporting real time status messages, including the number of bytes read from the disk image, back to the KVM vMedia client 22 with regard to the mounting and unmounting of the disk image files that the user is working with.

Still another advantage of the system 10 is that the disk images may not be accessible to the host server 14 via its network connection. Typically the host server uses the in-band network, which is the network that allows access by the public or general corporate users, but it is not on the out-of-band network, the one that is used for management of devices. This division of the networks is a security feature because a potential hacker of the host server does not have access to the out-of-band (management) network. This is a general advantage of KVM/vMedia appliances that is maintained with the present system 10 and method.

While various embodiments have been described, those skilled in the art will recognize modifications or variations which might be made without departing from the present disclosure. The examples illustrate the various embodiments and are not intended to limit the present disclosure.

Therefore, the description and claims should be interpreted liberally with only such limitation as is necessary in view of the pertinent prior art.

1. A method for remotely accessing disc images using a KVM/vMedia client, the method comprising:
using the KVM/vMedia client on a user's computing device to communicate a first message to a controller at a site, the first message operating as an inquiry of available disk image files from at least one disk image server;
receiving the first message at the controller and using the controller to transmit back to the computing device a second message that identifies at least one available disk image file on the disk image server;
using the KVM/vMedia client to transmit a third message representing a selected disk image file back to the controller;
using the controller to receive the third message, and to mount the selected disk image file in the controller using a predetermined file system, and to expose the mounted disk image file to a host computing system in communication with the controller; and
using the KVM/vMedia client to access the host computing system via the controller and to display the mounted disk image file on the user's computing device.

2. The method of claim 1, wherein communicating the first message to a controller at a site comprises transmitting the first message to a KVM appliance.

3. The method of claim 1, wherein communicating the first message to a controller at a site comprises transmitting the first message to a baseband management controller (BMC).

4. The method of claim 1, wherein transmitting the first, second and third messages comprises transmitting first, second and third AVMP (Avocent Messaging Protocol) messages.

5. The method of claim 1, further comprising transmitting a fourth message from the controller to the KVM/vMedia client, after mounting the disk image file in the controller, informing the KVM/vMedia client that the selected disk image file has been successfully mounted.

6. The method of claim 1, further comprising using the controller to send status messages back to the KVM/vMedia client informing the KVM/vMedia client of disk image interactions between the host computing device and the disk image server.

7. The method of claim 1, further comprising using the KVM/vMedia client to send a message to the controller to unmount the mounted disk image file.

8. The method of claim 7, further comprising using the controller to unmount the mounted disk image file from the host computing device, and to send a message back to the KVM/vMedia client that an unmounting of the mounted disk image file was successfully performed.

9. The method of claim 1, wherein mounting the selected disk image file in the controller using a predetermined file system comprises mounting the selected disk image file in the controller in accordance with one of:
a NFS (Network File System) protocol;
a CIFS (Common Internet File System) protocol; and
a HTTP (via DavFS) mount protocol.

10. The method of claim 1, wherein exposing the mounted disk image file to a host computing system in communication with the controller comprises exposing the mounted disk image file to a host server.

11. The method of claim 1, wherein using the KVM/vMedia client on a user's computing device to communicate a first message to a controller at a site comprises using the KVM/vMedia client on at least one of:
a workstation computer;
a laptop computer;
a smartphone; and
a computing tablet.

12. A method for remotely accessing disc images using a KVM/vMedia client, the method comprising:
using the KVM/vMedia client on a user's computing device to communicate a first universal resource locator (URL) to a controller at a site, the first URL operating as an instruction to cause the controller to access a selected disk image server and to obtain information on disk image files available from the selected disk image server;
receiving the first URL at the controller and using the controller to transmit back to the user's computing device a directory of available disk image files on the selected disk image server;
using the KVM/vMedia client to display the directory on a display of the user's computing device;
using the KVM/vMedia client to generate a second URL in accordance with a selection of a specific disk image file by the user, and transmitting the second URL back to the controller;
using the controller to receive the second URL and to mount a specific disk image file associated with the second URL, using a predetermined file system, and to expose the mounted disk image file to a host computing system in communication with the controller; and
using the KVM/vMedia client to access the host computing system via the controller and to display the mounted disk image file on the user's computing device.

13. The method of claim 12, wherein communicating the first URL to a controller comprises communicating the first URL to a KVM appliance.

14. The method of claim 12, wherein communicating the first URL to a controller comprises communicating the first URL to a baseband management controller (BMC).

15. The method of claim 12, further comprising using the controller to send a message to the user's computing device that mounting of the specific disk image file was successful.

16. The method of claim 15, wherein using the controller to send a message to the user's computing device that mounting of the selected disk image file was successful comprises sending an Avocent Message Protocol (AVMP) message.

17. The method of claim 12, wherein mounting the specific disk image file using a predetermined file system comprises using one of:
a NFS (Network File System) protocol;
a CIFS (Common Internet File System) protocol; and
a HTTP (via DavFS) mount protocol.

18. The method of claim 12, further comprising using the user's computing device to send a message to the controller informing the controller to unmount the selected disk image.

19. The method of claim 18, further comprising:
using the controller to inform the host computing device that media associated with the selected disk image is being ejected, and using the controller to unmount the disk image; and periodically transmitting messages from the controller to the KVM/vMedia client informing the KVM/vMedia client how much data has been read by the host computing device from the selected disk image file.

20. A system for remotely accessing disc images using a KVM/vMedia client, the system comprising:
a KVM/vMedia client running on a user's computing device, and configured to communicate a first message to a controller at a site, the first message operating as an inquiry of available disk images from at least one disk image server;
the controller configured:
to receive the first message;
to transmit back to the computing device a second message that identifies at least one available disk image file on the disk image server;
to receive a third message from the KVM/vMedia client representing a selected disk image file; and
to mount the selected disk image file in the controller using a predetermined file system, and to expose the mounted disk image file to a host computing system in communication with the controller for access and use by the user's computing device.
